(19) United States
(12) Patent Application Publication
(10) Pub. No.: US 2026/0297446 A1
(43) Pub. Date: Oct. 1, 2026

(54) DEVICE FOR THE TREATMENT OF A SOLID FEEDSTOCK, COMPRISING RECYCLING OF THE SOLID FEEDSTOCK

(71) Applicants: IFP ENERGIES NOUVELLES, Rueil-Malmaison (FR); TOTALENERGIES ONETECH, COURBEVOIE (FR); THYSSENKRUPP UHDE GMBH, DORTMUND (DE); AVRIL, PARIS (FR); COMMISSARIAT A L'ENERGIE ATOMIQUE ET AUX ENERGIES ALTERNATIVES, PARIS (FR); AXENS, RUEIL-MALMAISON (FR); BIONEXT, VENETTE (FR)

(72) Inventors: Sebastien GONNARD, Rueil-Malmaison Cedex (FR); Mathieu MORIN, Rueil-Malmaison Cedex (FR); Jean-Philippe HERAUD, Rueil-Malmaison Cedex (FR)

(73) Assignees: IFP ENERGIES NOUVELLES, Rueil-Malmaison (FR); TOTALENERGIES ONETECH, COURBEVOIE (FR); THYSSENKRUPP UHDE GMBH, DORTMUND (DE); AVRIL, PARIS (FR); COMMISSARIAT A L'ENERGIE ATOMIQUE ET AUX ENERGIES ALTERNATIVES, PARIS (FR); AXENS, RUEIL-MALMAISON (FR); BIONEXT, VENETTE (FR)

(21) Appl. No.: 19/476,809

(22) PCT Filed: Apr. 8, 2024
(86) PCT No.: PCT/EP2024/059442

§ 371 Date: Oct. 20, 2025

(30) Foreign Application Priority Data
Apr. 21, 2023 (FR) FR2304026

(51) Int. Cl. C10L 9/08; C10B 53/02; C10B 57/10; C10B 57/14; C10G 2/00; C10J 3/48; C10J 3/66; C10J 3/72; C10K 1/00; C10K 1/10; C10K 1/22; C10K 3/04; C10L 5/44

(52) U.S. Cl. CPC C10L 9/083; C10B 53/02; C10B 57/10; C10B 57/14; C10G 2/30; C10J 3/485; C10J 3/66; C10J 3/723; C10K 1/003; C10K 1/101; C10K 1/22; C10K 3/04; C10L 5/44; C10G 2300/1014; C10J 2300/092; C10J 2300/1618; C10J 2300/1659; C10J 2300/1807; C10L 2290/08; C10L 2290/10; C10L 2290/24; C10L 2290/58; C10L 2290/60

(57) ABSTRACT

The invention relates to a device for the treatment of a feedstock, comprising a furnace (301) with an enclosure comprising an inlet (316) and an outlet (304) for the feedstock and an inlet (317) and an outlet (318) for a gas. The device comprises a feedstock recovery system (306) comprising a recovery line (305) connected to the enclosure at the feedstock outlet (304) and comprising a sampling and/or analysis means (319). It comprises two lines in parallel downstream of the sampling and/or analysis means (319), one of the lines being a line leading to a storage tank (308) and another line being a line leading to a port (303) for reintroducing the feedstock into the furnace (301).

The invention also relates to a drying or torrefaction process and to an installation for producing hydrocarbons using the drying or torrefaction device.

### TECHNICAL FIELD

The invention relates to the field of feedstock treatment devices, such as furnaces, notably multiple hearth furnaces, for bringing a solid into contact with a gas.

The devices at which the invention is aimed are notably drying or torrefaction furnaces for reducing or eliminating the moisture of a feedstock (drying operation) or for modifying the physico-chemical properties of the feedstock (torrefaction operation).

In general, multiple hearth furnaces can be implemented in various types of processes, including, in a non-limiting manner, incineration of waste material, calcination for the manufacture of cement, for example, regeneration of activated carbon, or pre-treatment of biomass.

More particularly, in the field of processes for the transformation of biomass, as described, for example, in the Applicant's patent application FR 2 997 414, the aim is to produce advanced biofuels (biodiesel and biokerosene) by thermochemical conversion of lignocellulosic biomass. The various steps of this process are (i) pre-treatment, (ii) gasification, (iii) conditioning of the synthesis gas, and (iv) Fischer-Tropsch synthesis.

The first step of pre-treating the biomass is carried out in order to prepare the biomass for its future injection into the gasifier. This step consists in the drying and the gentle thermal degradation of the wood, referred to as torrefaction. This pre-treatment requires a significant supply of heat in order to first of all raise the temperature of the biomass to an adequate level for the drying phase, then eliminate the water present in the biomass, and then raise and maintain the temperature of the dry biomass at an adequate level for the torrefaction operation. This supply of heat is generally effected by bringing the biomass into contact with a stream of hot gas. This pre-treatment step is generally performed using furnaces, such as multiple hearth furnaces, for the drying step and/or for the torrefaction step. The furnaces can thus serve as driers and/or torrefaction equipment.

### PRIOR ART

FIG. 1 shows an example of a multiple hearth furnace for bringing a solid material into contact with a gas according to the prior art, described as such in patent application US 2016/356 548 A. According to this embodiment, the furnace (10) is made up of a closed cylinder (11), (12) and (13) comprising 8 hearth-plates (1) to (8). A central shaft (15) is rotated about the vertical axis (16) by a mechanism (17). The shaft makes it possible to rotate arms (18) which comprise teeth (19) and which are disposed above the hearth-plates. During the rotation of the shaft, the teeth are moved and, depending on their orientation, move the solid either towards the interior or towards the exterior of the hearth-plate. The solid is introduced at the top of the furnace through the feed inlet (20) and circulates towards the bottom, from hearth-plate to hearth-plate, either through the exterior holes (222), (224), (226) and (228) or through the central holes (211), (213), (215) or (217), before exiting the reactor through the outlet orifice (24). The gas, which supplies its heat to the solid, is introduced tangentially either at the bottom of the furnace (counter-current movement relative to the solid via orifices 27), or at the top of the furnace (co-current movement) and circulates through the same peripheral or central holes on each hearth-plate.

Such furnaces are, on the whole, satisfactory. Nevertheless, it sometimes happens that the feedstock leaving the furnace does not meet the prescribed specifications, for example in terms of drying or torrefaction performance. The drying performance may notably be specified as a target moisture content for the feedstock, while torrefaction performance may relate to the Anhydrous Weight Loss (AWL). The anhydrous weight corresponds to the weight of a feedstock no longer containing moisture. The anhydrous weight loss corresponds to the degradation of the feedstock during torrefaction.

Patent application FR3015513 describes a drying and torrefaction process incorporating a step of combustion of the torrefaction gases with the recirculation of the combustion flue gases within the drying furnace. This process is illustrated in FIG. 2 which includes a drying loop depicted in continuous line indicated by the streams 104, 105 and 107 and a torrefaction loop depicted in dotted line indicated by the streams 108, 110, 111, 112 and 113. In the process in FIG. 2, the wet biomass 101 enters the drying furnace (dryer) A to have its water content reduced down to values below 10 wt %. The drying gases 105 that are generated are extracted and sent into a heat exchanger C in which they are heated and then reintroduced into the drying unit via the stream 107. The dried biomass 102 is then sent to the torrefaction furnace (torrefaction equipment) B where movement is counter-current in relation to the gas. The thermal degradation of the biomass produces torrefaction gases which are extracted from the unit via the stream 108, and a torrefied solid residue which exits via the stream 103. The torrefaction gases 108 are sent to a combustion chamber D where they are burnt in the presence of oxygen with a make-up quantity of fuel 109 to produce hot flue gases at a temperature in excess of 700° C. All of these flue gases are reused in the process:
A first proportion is fed into the heat exchanger C via the stream 111 in order to heat the gases of the drying zone. The flue gases thus cooled are reintroduced into the torrefaction furnace via the stream 112.
The other proportion of the flue gases 113 is recirculated and feeds into the gases entering the dryer (stream 104), mixing with the heated gases 107.

Patent application US 2012/0117815 A1 is also known and is concerned with the torrefaction of biomass and describes methods for evaluating the degree of torrefaction of the feedstock leaving the torrefaction furnace. However, that patent application merely measures the level of torrefaction at the outlet and proposes no solution for improving the level of torrefaction.

### SUMMARY OF THE INVENTION

The object of the invention is to propose an improved treatment device making it possible to obtain at the outlet of the device a feedstock that conforms to the target (drying or torrefaction) performance thereby limiting the level of non-compliant product (the product being the dried or torrefied feedstock) at the outlet.

In order to do this, the invention relates to a device for the treatment of a feedstock containing solid particles, the treatment preferentially being drying or torrefaction, the device comprising a furnace comprising an enclosure of which the longitudinal axis is vertical in the operating position, the enclosure comprising at least an inlet and an outlet for said feedstock and at least an inlet and an outlet for a gas able to come into contact with the solid particles. In addition, the device comprises a feedstock recovery system for recovering said feedstock, the feedstock recovery system comprising at least a recovery line connected to the feedstock outlet of the enclosure, the recovery line being in fluidic connection with a sampling and/or analysis means, for the in-situ or ex-situ analysis of the feedstock so as to measure a parameter indicative of the treatment (of the drying or of the torrefaction for example) of the feedstock, the recovery line comprising at least two lines in parallel downstream of the sampling and/or analysis means, in the direction of circulation of the feedstock, at least one of the lines being a removal line, the removal line preferably leading to a storage tank, and at least another line being a recirculation line leading to a port allowing the feedstock to be reintroduced into the furnace, each removal or recirculation line comprising a throttling means.

Advantageously, the recovery system comprises a control means for controlling the opening and closing of the throttling means, the control means preferably being connected to said sampling and/or analysis means.

As a preference, the feedstock recovery system comprises several recirculation lines each leading to a different port into the enclosure, the various ports for the various lines being situated at different altitudes along the enclosure.

According to a variant of the invention, at least one recirculation line, preferably each recirculation line, comprises an intermediate tank situated between the throttling means of the recirculation line and the port for reintroducing the feedstock into the furnace.

According to one configuration of the invention, the indicative parameter is the measurement of the moisture content of the feedstock and either the sampling and/or analysis means comprises a sampling means, an oven and a mass-measuring system for measuring the mass before and after the feedstock passes through the oven, the difference in mass being indicative of the moisture content of the feedstock, or the sampling and/or analysis means comprises an in-line analyser, preferably using infrared or microwaves, for measuring the moisture content of the feedstock in situ.

According to another configuration of the invention, the indicative parameter is the level of torrefaction of the feedstock and either the sampling and/or analysis means comprises a feedstock sampling means and a device for measuring the upper calorific value and/or the lower calorific value, the upper calorific value and/or the lower calorific value being directly linked to the level of torrefaction of the feedstock, or the sampling and/or analysis means comprises an in-line system for characterizing the colour of the feedstock, the colour of the feedstock being directly linked to the level of torrefaction.

According to one preferred embodiment of the invention, the furnace is a multiple hearth furnace, the enclosure comprising:
a plurality of hearth-plates distributed along the longitudinal axis in the operating position, each hearth-plate comprising an upper surface able to receive solid particles and at least one passage opening allowing the solid particles and the gas to pass through said hearth-plate,
at least one agitation arm associated with each hearth-plate, each agitation arm comprising agitation teeth extending from the agitation arm towards the upper surface of the hearth-plate associated with the agitation arm,
means for driving the rotation of the agitation arms about the longitudinal axis of the enclosure,
   the port for each recirculation line being situated above one of said hearth-plates so as to introduce the feedstock at the level of said hearth-plate, each recirculation line preferably allowing the feedstock to be introduced at the level of a different hearth-plate.

The invention also relates to a process for the drying or torrefaction of a feedstock containing solid particles (and possibly fluids, such as water, contained in the solid particles) using a device as described hereinabove, wherein at least the following steps are performed:
said feedstock made up of solid particles, and a gas are introduced into the furnace;
the dried or torrefied feedstock is recovered at the outlet of the furnace;
a parameter indicative of the drying or of the torrefaction of the feedstock is measured using the dried or torrefied feedstock leaving the furnace;
depending on said indicative parameter measured, said (dried or torrefied) feedstock is sent to a removal line, where the feedstock may for example be stored in the storage tank, and/or the (dried or torrefied) feedstock is sent to at least one recirculation line so that it can be reintroduced into the furnace.

As a preference, depending on said indicative parameter, the dried or torrefied feedstock is introduced into a recirculation line which terminates at a port defined according to its altitude in the furnace.

Advantageously, the measuring of the indicative parameter is performed in-line by an analyser.

Alternatively, the measuring of the indicative parameter is performed by taking a sample of the dried or torrefied feedstock using the sampling and/or analysis means, the measurement being performed on the sample off-line.

According to one configuration of the invention, the indicative parameter is a moisture content of the feedstock and the mass of the taken sample is measured, then the taken sample is placed in an oven in order to eliminate the moisture it contains and the mass of the taken sample that has been in the oven is measured, the moisture content being defined as the ratio of the difference between the mass of the taken sample and of the taken sample which has been in the oven, to the mass of the taken sample.

According to another configuration of the invention, the indicative parameter is a level of torrefaction of the feedstock and the upper calorific value and/or the lower calorific value of the taken sample is/are measured, the upper calorific value and/or the lower calorific value being directly linked to the level of torrefaction.

The invention additionally relates to an installation for producing liquid hydrocarbons from a feedstock containing at least a fraction of biomass and possibly at least a fraction of another feedstock, comprising:
at least a feedstock-pre-treatment unit comprising a drying unit, a torrefaction unit, possibly a granulation unit, and a comminution unit;
possibly a combination unit comprising a pipe able to reunite the effluents originating from the various pre-treatment units;
a gasification unit for gasifying the pre-treated effluents and comprising at least an entrained-flow reactor;
a conditioning unit for conditioning the synthesis gas and comprising:
   a scrubbing unit for scrubbing the gas stream with water and fractionating it so as to split the stream of synthesis gas into at least two effluents;
   at least a guard bed for eliminating halogenated compounds in one of said two effluents situated upstream of a conversion unit for the steam conversion of carbon monoxide;
   a catalytic hydrolysis unit;
   a recombining unit recombining the effluents originating respectively from the steam carbon monoxide conversion unit and from the catalytic hydrolysis unit;
a scrubbing unit that uses water to scrub the effluent originating from the synthesis gas conditioning unit;
an acidic-gas removal unit that removes the acidic gases contained in the scrubbed effluent;
a purification unit for the final purification of the scrubbed and de-acidified effluent and comprising at least a guard bed;
a catalytic Fischer-Tropsch synthesis reaction unit.

In addition, the drying unit and/or the torrefaction unit comprises a device as described hereinabove.

As a preference, the installation further comprises at least a hydrotreatment and/or isomerization unit acting on the hydrocarbon fractions originating from the catalytic Fischer-Tropsch synthesis reaction unit.

### LIST OF FIGURES

Other features and advantages of the device, of the process and of the installation according to the invention will become apparent upon reading the following description of nonlimiting exemplary embodiments with reference to the appended figures described below.

FIG. 1 depicts a multiple hearth furnace.

FIG. 2 illustrates a process for the drying and torrefaction of biomass according to the prior art.

FIG. 3 illustrates a drying or torrefaction device according to the invention.

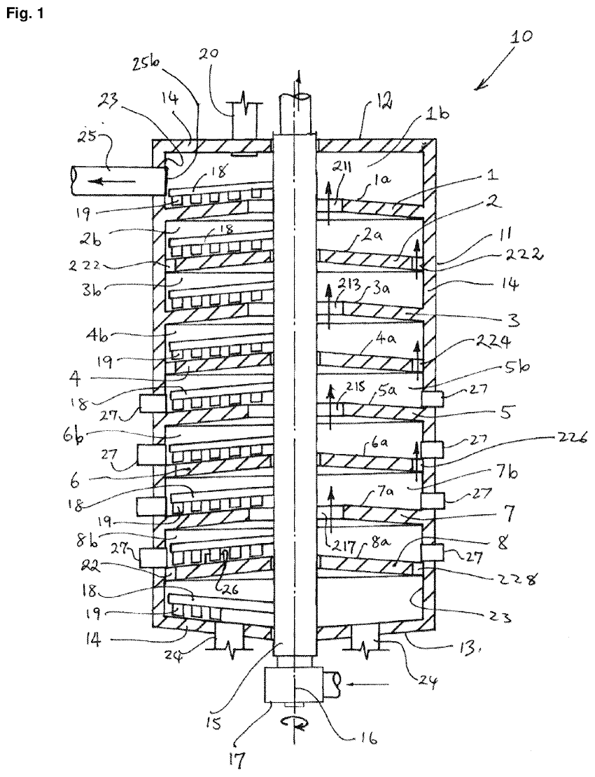

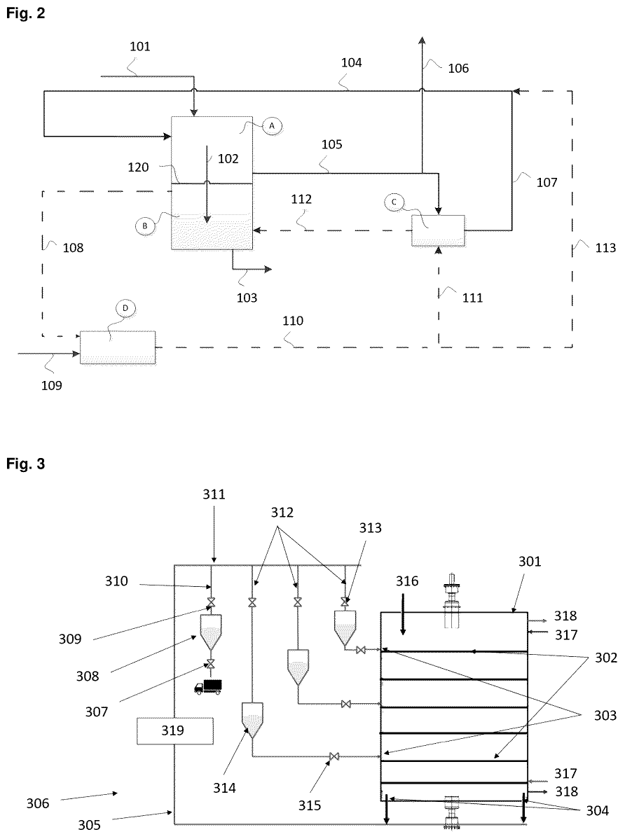

### DESCRIPTION OF THE EMBODIMENTS

The terms “upper”, “lower”, “top”, “middle”, “bottom”, are to be understood relative to the axis that is vertical when the multiple hearth furnace is in the operating position (also referred to as the service position).

The terms “vertical”, “horizontal”, “level” or “altitude” are to be understood with reference to the operating position.

The terms “upstream” and “downstream” are to be understood with reference to the direction in which the feedstock circulates through the device.

The terms “first”, “second”, “third”, “previous” and “next” are to be understood with reference to the direction in which the feedstock passes through the enclosure, preferably vertically from top to bottom.

What is meant by “solid particles” is agglomerations of various sizes of solid, which may contain a compound in the liquid state, notably water, in variable proportions. The solid particles may correspond to a biomass feedstock. The biomass feedstock can advantageously vary depending on its origin. It may be from wood or from by-products of wood, such as waste material produced by forestry (forest remains), sawmills, wood processing industries. It may also originate from industrial by-products such as sludge or agrifood waste. The biomass may also come from traditional agriculture and be made up of residues such as straw, coppice, bagasse, and also what's grown especially for energy generation purposes (miscanthus, short rotation coppice, etc.). Finally, it may correspond to organic waste, such as urban waste comprising sewage sludge; household waste may also constitute the feedstock. Preferably, the biomass feedstock can be lignocellulosic biomass or cellulose, and preferably lignocellulosic biomass. The biomass feedstock may also originate from algae. The feedstock may be composed of solid particles. In particular, when the solid according to the invention corresponds to a biomass feedstock, it may contain a certain content of fluid in the liquid state, and particularly water (it has a moisture content).

The solid particles may notably be obtained by prior mechanical treatment such as shredding.

The invention relates to a device for the treatment, notably for the drying or torrefaction, of a feedstock made up of solid particles (a feedstock made up of solid particles and possibly of fluids contained in these solid particles, notably water). The feedstock is notably a feedstock containing hydrocarbons in which the solid particles may be particles originating from biomass, for example shredded word and/or plant residue. The device comprises a furnace comprising an enclosure of which the longitudinal axis is vertical in the operating position, and the enclosure comprises at least an inlet and an outlet for the feedstock made up of solid particles and at least an inlet and an outlet for a gas able to come into contact with the solid particles. Thus, in the furnace, the hot gas may exchange heat with the feedstock and thus treat same (dry or torrefy same for example), depending on the temperatures employed and on the residence time that the feedstock spends in the furnace. For drying, the furnace temperature is generally between 90 and 110° C., and for torrefaction it is generally between 200 and 350° C.

In addition, the device comprises a feedstock recovery system, the feedstock recovery system comprising at least a recovery line connected to the (partially or fully) treated feedstock outlet of the enclosure, the recovery line being in fluidic connection with a sampling and/or analysis means, for the in-situ or ex-situ measurement of a parameter indicative of the treatment (drying or torrefaction for example) of the feedstock.

The sampling and/or analysis means may comprise a feedstock sampling means for taking a sample so that it can be analysed ex-situ, for example in a laboratory, and/or it may comprise an analysis means for taking measurements directly, with or without taking a sample of the feedstock. In other words, the analysis means may be incorporated into the recovery system or may be independent, for example when the analysis of the sample taken is performed ex-situ.

The recovery line comprises at least two lines in parallel downstream of the sampling and/or analysis means, in the direction of circulation of the feedstock, at least one of the lines being a (fully treated) feedstock removal line, and at least another line being a recirculation line leading to a port allowing the (partially treated) feedstock to be reintroduced into the furnace. As a preference, the removal line may lead to a storage tank. Alternatively, the removal line may lead directly to a unit that uses the treated (notably dried or torrefied) feedstock, or may lead to lorries for transporting the feedstock.

Thus, by virtue of the sampling and/or analysis means, it is possible to characterize the feedstock leaving the furnace by the indicative parameter, in order to know its level of treatment (level of drying or of torrefaction). Depending on this indicative parameter, it is possible:
either to elect to send the (fully treated) feedstock to a storage tank or to a unit for example, via the removal line, the feedstock then conforming to the predefined criteria of treatment (drying or torrefaction for example);
or to elect to recirculate the (partially treated) feedstock if it is insufficiently treated (dried or torrefied for example), by reintroducing it into the furnace via the recirculation line.

By virtue of the device of the invention, it is thus possible to limit the amount of insufficiently treated feedstock and thus improve the treatment performance.

The gas according to the invention may, depending on the intended application, be air, but may also be recirculated combustion gases, carbon dioxide, water vapour, or else an inert gas such as helium or nitrogen.

According to a preferred implementation of the invention in which the system is implemented in the context of a process for the drying and/or torrefaction of a biomass, the gas may be an inert gas such as helium, nitrogen, or a mixture of these gases with recirculated gases originating from a previous drying and/or torrefaction step. According to one implementation of the invention in which the system is implemented in the context of a process for the torrefaction of a biomass, the gas may also be water vapour (or steam).

According to the invention, each recirculation and/or removal line comprises a throttling means (a valve for example) to allow or prevent the circulation of the feedstock in said line, notably in the removal or recirculation line. Specifically, if the indicative parameter satisfies the predefined criteria (a predefined range with a minimum value and a maximum value for example or possibly just a threshold), the feedstock may be introduced directly into the removal line in order to be sent for example to the storage tank. The throttling means of the removal line may then be opened and the throttling means of the recirculation line closed in order to send the feedstock to the storage tank for example and prevent it from being reintroduced into the furnace, which might cause undesired over-treatment (over-drying or over-torrefaction for example).

For example, in the case of drying, the predefined indicative criteria may comprise a moisture content of between 1 and 35%, preferably between 2 and 20% and more preferably still, between 3 and 10%.

For example, in the case of torrefaction, the predefined indicative criteria may comprise a level of torrefaction (level of anhydrous weight loss) of between 5 and 60%, preferably between 15 and 45% and more preferably still, between 20 and 30%.

For that, the residence time that the feedstock spends in the furnace may be between 10 and 100 minutes, preferably between 15 and 60 minutes, and more preferably still, between 25 and 40 minutes.

When the recovery system comprises a plurality of recirculation lines, the circulation through each recirculation line may be dependent on the value of the indicative parameter measured. In other words, each recirculation line is configured to allow the circulation of the feedstock according to the measured indicative parameter, and the more remote the measured indicative parameter is from the predefined criteria, the higher the height (altitude) of the port at which the recirculation line through which the feedstock can circulate terminates (if the feedstock passes through the furnace vertically from top to bottom) in the furnace in order to ensure that the residence time in the furnace is long enough to obtain the target level of treatment, notably of drying or torrefaction (the level that is within the predefined criteria). As a result, it is possible to elect to introduce the feedstock into the reactor at a greater or lesser distance upstream, in the direction in which the feedstock passes through the reactor. Furthermore, it is also possible to reintroduce the feedstock via a number of ports at a given height, for example so that the feedstock reintroduced is better distributed around the circumference of the reactor.

Advantageously, the recovery system may comprise at least three recirculation lines, one terminating at a port situated in the upper part of the furnace, one terminating at a port situated in the bottom part of the furnace and the last of the three recirculation lines terminating at the middle of the furnace (which is to say at an altitude situated between the port that is situated in the top part of the furnace and the one that is situated in the bottom part of the furnace).

According to a preferred configuration of the invention, the furnace may be a multiple hearth furnace with a succession of hearth-plates from top to bottom in the enclosure, the hearth-plates in the succession being configured alternately so that they move the feedstock from the inside towards the outside and then from the outside towards the inside, or vice versa.

The hearth-plates (or at least their median plane) may preferably be substantially horizontal in the service position of the multiple hearth furnace.

What is meant by “the inside towards the outside” is from the axis of the reactor towards the exterior wall of the reactor; what is meant by “the outside towards the inside” is from the exterior wall of the reactor towards the axis of the reactor. For example, if the first hearth-plate (the one nearest the top) moves the feedstock from the inside towards the outside, then the second hearth-plate (the one that directly follows the first hearth-plate) moves the feedstock in the opposite direction, from the outside towards the inside, and the third hearth-plate (the one that directly follows the second hearth-plate) then moves the feedstock from the inside towards the outside and so on.

In this preferred configuration, there may be as many recirculation lines as there are hearth-plates configured to cause the feedstock to circulate from the outside towards the inside and the ports for each recirculation line may each terminate just above one of these hearth-plates which are configured to cause the feedstock to circulate from the outside towards the inside. Thus, each recirculation line may bring the feedstock onto a distinct hearth-plate able to cause the feedstock to circulate from the outside towards the inside.

Moreover, the throttling means may make it possible to control the flow rate of the feedstock in each recirculation line for reintroducing it into the furnace.

Advantageously, the recovery system may be configured so that the circulation of the feedstock through one line (a removal or a recirculation line) makes it impossible for the feedstock to be circulated in the other lines. Thus, each recirculation or removal line is devoted to a predetermined range of the measured indicative parameter. In other words, if the throttling means (valve) of one line (removal or recirculation line) is open, the other throttling means (valve) of the other lines may advantageously be closed.

As a preference, the recovery system may comprise a control means (or feedback-control means) for controlling (feedback-controlling) the opening and closing of the throttling means, the control means preferably being connected to said sampling and/or analysis means. Thus, depending on the indicative parameter measured, it is possible to manage the opening and the closing of the various throttling means of the various lines in such a way as to drive the feedstock towards the storage tank for example via the removal line or towards the desired port for reintroducing the feedstock into the furnace.

According to one advantageous implementation of the invention, the feedstock recovery system may comprise several recirculation lines each leading to a different port into the enclosure, the various ports for the various lines being situated at different altitudes along the enclosure.

Of course, the closer to the top of the furnace the feedstock is introduced, the longer the time it spends in the furnace and the greater the extent to which it is treated (dried or torrefied for example).

By distributing the orifices of the various lines at different altitudes (or heights) in the furnace, it is possible to refine the treatment (notably drying or torrefaction) parameter that can be obtained at the end of the recirculation according to the indicative parameter measured before the recirculation. For example, if the feedstock has been treated (dried or torrefied for example) only slightly, it can advantageously be reintroduced into the top part of the furnace so that it experiences a residence time in the furnace that makes it possible to obtain a level of treatment (notably drying or torrefaction) that falls within the predefined criteria at the end of the recirculation. On the other hand, if the feedstock has a level of treatment (drying or torrefaction for example) that is only slightly below the minimum value for the target criteria, it may advantageously be reintroduced into the bottom part of the furnace so that it has a fairly short residence time in the furnace so as to obtain a level of treatment (drying or torrefaction for example) that falls within the predefined criteria at the end of the recirculation and avoiding undesired over-treatment (notably over-drying or over-torrefaction) (outside of the maximum value of the predefined criteria).

In addition, by distributing a number of ports at different altitudes in the furnace, it is possible to select the required altitude to avoid over-treatment (notably over-drying or over-torrefaction) (outside of the maximum value of the predefined criteria), this over-treatment (notably this over-drying or over-torrefaction) then leading to the elimination (rejection) of the feedstock which can then no longer be used for the target application. What is meant by elimination (rejection) of the feedstock is that the over-treated (over-dried or over-torrefied for example) feedstock will not be used for the target application. This embodiment therefore makes it possible to limit the produced feedstock that will be lost without being used.

This embodiment is also advantageous at the time of calibration because the feedstock can advantageously be reintroduced at the lowest level in order to see how the feedstock reacts to this minimal recirculation and then, on the basis of the results, be gradually recirculated higher and higher up in order to establish methodologies that make it possible to select the level of treatment (notably drying or torrefaction) at the end of recirculation according to this level prior to recirculation and according to the port at which the feedstock is reintroduced.

This calibration makes it possible to make the device easier to use and to limit the number of recirculation operations needed in order to obtain indicative parameters that fall within the predefined criteria.

As a preference, the ports of the various lines can be distributed uniformly along the vertical axis on the furnace, in order further to refine the target level of treatment (drying or torrefaction for example) according to the level of treatment (drying or torrefaction for example) prior to recirculation.

Advantageously, at least one recirculation line, preferably each recirculation line, may comprise an intermediate tank situated between the throttling means of the recirculation line and the port for reintroducing the feedstock into the furnace. Thus, a buffer store may be constituted and the feedstock may be stored in this buffer store for subsequent reintroduction without the need to shut down the device.

As a preference, for this embodiment, a second throttling means may then be positioned on the recirculation line between the intermediate tank and the port for that line, so as to control the introduction of the feedstock from the intermediate tank into the furnace. This second throttling means (notably a valve) may be identical to the throttling means situated upstream of the intermediate tank. It may also be connected to the control means (feedback-control means).

According to a first variant of the invention, the indicative parameter may be the measurement of the moisture content of the feedstock, notably when the device is a drying device. Specifically, the moisture content (the ratio between the mass of water contained in the feedstock and the total mass of the feedstock) is directly linked to the drying performance.

In this first variant, the sampling and/or analysis means may comprise a means for sampling the feedstock, such as a sampler, for taking a sample of the feedstock at the outlet of the furnace. The mass of this taken sample may then be measured in a mass measuring means, such as scales, then the sample may be placed in an oven where it can be heated to eliminate all of the water it contains. The mass of the taken sample that has been in the oven is then measured by means of a mass measuring means (identical to or different from the previous means used for measuring before placing in the oven). The difference in sample mass between entering and exiting the oven corresponds to the moisture that had been present in the sample taken and that disappeared in the oven. Thus, the moisture content of the taken sample can be deduced therefrom. The device may comprise the one or more mass-measuring means and the oven and they may be connected (or linked) to the sampling means such that the taken sample is conveyed to the mass-measuring means and then to the oven and either once again to the mass-measuring means, or to another mass-measuring means. The one or more mass-measuring means thus forms a mass-measuring system for measuring the mass of the feedstock (the feedstock sample) before and after it spends time in the oven.

Alternatively, these operations of measuring the mass of the sample and placing it in an oven may be performed away from the device by an operator who then collects the sample in the sampling and/or analysis means. The sample is then analysed ex-situ.

This first variant allows good precision of the parameter indicative of drying but does not provide an immediate result, and therefore does not allow in-line measurement. Specifically, it may take around 24 hours to obtain the moisture content of the feedstock.

Alternatively, in this first variant, the sampling and/or analysis means may comprise an in-line analyser for taking the measurement in situ. It is notably possible to use infrared or microwave in-line analysers to measure the moisture content of the feedstock. This solution is particularly advantageous because it allows both precise measurement and immediate results.

According to a second variant of the invention, the indicative parameter may be the level of torrefaction of the feedstock, which is to say the anhydrous weight loss of the feedstock, notably when the device is a torrefaction device. This parameter is important for the units which may be downstream of the torrefaction device, notably when this is a granulation unit, a comminution unit or a pneumatic transport unit. Specifically, for transport, torrefaction makes the torrefied powder more uniform in size and shape, thus making transport easier.

In this second variant, the sampling and/or analysis means may comprise a means for sampling the feedstock, such as a sampler, for taking a sample of the feedstock at the outlet of the furnace. The upper calorific value and/or the lower calorific value of the sample can then be measured.

The “upper calorific value” is the name given to the amount of energy released by complete combustion of one unit of the feedstock, the water vapour (steam) being assumed to be condensed and its heat recuperated.

The “lower calorific value” is the name given to the amount of energy released by complete combustion of one unit of the feedstock, disregarding the heat of condensation of the water, in contrast with the upper calorific value.

The upper and lower calorific values can be used to quantify the level of torrefaction.

The upper and lower calorific values can be measured using a calorimeter that measures the mass, the amount of heat released during combustion under oxygen (often by way of the increase in temperature brought about by the combustion) and also the initial moisture of the sample. The result is expressed in J/kg.

The upper and lower calorific values are physico-chemical properties of the solid that may be directly linked to the anhydrous weight loss. In other words, using the upper and lower calorific values measured, it is possible directly to determine the anhydrous weight loss and therefore the level of torrefaction. A prior calibration step is generally employed in order to link the upper calorific value or the lower calorific value to the anhydrous weight loss. In order to do this, the device may comprise a device for measuring the upper calorific value and/or the lower calorific value and comprising for example a calorimeter. In that case, a sample may be taken for example by an operator and the sample may be analysed in the calorimeter.

Alternatively, these operations of measuring the upper or lower calorific value may be performed away from the device by an operator who then collects the sample in the sampling and/or analysis means. In that case, the analysis is performed ex-situ.

This second variant allows good precision on the parameter indicative of torrefaction but does not provide an immediate result, and therefore does not allow in-line measurement, given the need to obtain complete combustion in the combustion chamber.

Alternatively, in this second variant, the sampling and/or analysis means may comprise an in-line system for characterizing the colour of the in-line feedstock, the colour of the feedstock possibly being directly linked to the level of torrefaction and not making it possible to determine the level of torrefaction from the identified colour of the feedstock alone. The colour characterization system may be an optical system (for example a camera) allowing the colour to be determined automatically and which may potentially be linked with the control means in order to adapt the opening and closing of the various throttling means instantaneously according to the feedstock colour determination in order to achieve feedback-control.

The colour characterization system may also comprise a transparent window. In that case, it is the operator who determines the colour of the feedstock and who can open or close the various throttling means according to this colour, or who can operate the control means in such a way as to command these openings and closings of the various throttling means.

It is also possible to use a photographic image capturing device and software which continuously analyses the colour of the photographs. In that case, the colour characterization system comprises a photographic image capture device and colour analysis software.

It is also possible to use infrared colour analysis. It is also conceivable to conduct continuous infrared spectroscopy of the solid, or RAMAN spectroscopy. Other types of continuous analysis of the solid may be envisioned without departing from the scope of the invention.

As a preference, the furnace may be a multiple hearth furnace and the enclosure may then comprise:
a plurality of hearth-plates distributed along the longitudinal axis vertical in the operating position, each hearth-plate comprising an upper surface able to receive solid particles and at least one passageway allowing the solid particles and the fluid to pass through said hearth-plate,
at least one agitation arm associated with each hearth-plate, each agitation arm comprising agitation teeth extending from the agitation arm towards the upper surface of the hearth-plate associated with the agitation arm,
means for driving the rotation of the agitation arms about the longitudinal axis of the enclosure.

Furthermore, the port of each recirculation line may advantageously be situated above one of the hearth-plates for introducing the feedstock at the level of that hearth-plate.

The use of a multiple-hearth furnace allows efficient operations of drying and torrefaction of the feedstock Specifically, the increase in number of the hearth-plates, combined with the rotating of the arms, allows good uniformity of treatment of the feedstock in this type of furnace. In addition, it allows a robust and flexible process capable of handling any type of biomass at a fairly high throughput.

As a preference, each recirculation line may culminate in the introduction of the feedstock at a different hearth-plate. In other words, the port for each recirculation line terminates at a different hearth-plate. Thus, the level of drying or torrefaction of the recirculated feedstock can be refined according to this very level prior to recirculation.

The invention also relates to a process for the drying or torrefaction of a feedstock made up of solid particles, preferably a hydrocarbon-containing or biomass feedstock, using a device as described hereinabove, wherein at least the following steps are performed:
the feedstock made up of solid particles (and any fluids that may be contained in solid particles, such as water), and a gas are introduced into the furnace, preferably into a multiple hearth furnace;
the dried or torrefied feedstock is recovered at the outlet of the furnace;
a parameter indicative of the drying or of the torrefaction of the feedstock is measured using the dried or torrefied feedstock leaving the furnace, the indicative parameter preferably being the level of drying (or feedstock moisture level) or the level of torrefaction;
depending on said indicative parameter, said feedstock is sent to a removal line, where the feedstock is for example stored in the storage tank, or the feedstock is sent to a recirculation line so that it can be reintroduced into the furnace.

The method according to the invention makes it possible to increase the quantity of feedstock that meets the predefined criteria thanks to the possibility of recirculating it when the level of drying or of torrefaction is insufficient. It thus enables an improvement in the drying or torrefaction performance.

According to one advantageous implementation of the invention, depending on said indicative parameter, the feedstock may be introduced into a recirculation line which terminates at a port defined according to its altitude in the furnace. Specifically, if the indicative parameter is fairly remote from the minimum value of the predefined criteria, then the feedstock may be reintroduced into the top part of the furnace, whereas if the indicative parameter is inferior, but close, to this minimum value, then the feedstock may be reintroduced into the bottom part of the furnace in order to avoid over-drying or over-torrefaction of the feedstock. To do this, use may be made of a recovery system which has a plurality of recirculation lines each terminating at a port situated at a different altitude on the furnace.

As a preference, the measuring of the indicative parameter is performed in-line by an in-line analyser. For example, the in-line analyser may be an infrared or microwave analyser for determining the moisture content of the feedstock. The in-line analyser may equally be a characterization system as described hereinabove, and the indicative parameter is then the colour of the feedstock which allows the level of torrefaction to be determined directly.

Alternatively, the measuring of the indicative parameter may be performed by taking a sample of the dried or torrefied feedstock using a sampling means as described hereinabove, at the outlet of the furnace. The measuring can then be performed on the sample off-line (ex situ).

According to a first configuration of the process of the invention, the indicative parameter may be the moisture content of the feedstock and the mass of the taken sample may be measured then the sample may be placed in an oven in order to eliminate the moisture it contains and then the mass of the sample that has been in the oven may be measured, the moisture content being defined as the ratio of the difference between the mass of the taken sample and of the sample which has been in the oven, to the mass of the taken sample. In this way it is possible to evaluate the moisture content using means that are simple and inexpensive (which is to say that do not involve infrared or microwave means).

According to a second configuration of the process of the invention, the indicative parameter may be the level of torrefaction of the feedstock and the upper calorific value and/or the lower calorific value of the taken sample may be measured, the upper calorific value and/or the lower calorific value being directly linked to the level of torrefaction (via a possible prior calibration step). The upper and lower calorific values may be determined by measurement using a calorimeter for example.

The invention also relates to an installation for producing liquid hydrocarbons from a feedstock containing at least a fraction of biomass and possibly at least a fraction of another feedstock, comprising:
at least a feedstock-pre-treatment unit comprising a drying unit, a torrefaction unit, possibly a granulation unit, and a comminution unit;
possibly a combination unit comprising a pipe able to reunite the effluents originating from the various pre-treatment units;
a gasification unit for gasifying the pre-treated effluents and comprising at least an entrained-flow reactor;
a conditioning unit for conditioning the synthesis gas and comprising:
   a scrubbing unit for scrubbing the gas stream with water and fractionating it so as to split the stream of synthesis gas into at least two effluents;
   at least a guard bed for eliminating halogenated compounds in one of said two effluents situated upstream of a conversion unit for the steam conversion of carbon monoxide;
   a catalytic hydrolysis unit;
   a recombining unit recombining the effluents originating respectively from the steam carbon monoxide conversion unit and from the catalytic hydrolysis unit;
a scrubbing unit that uses water to scrub the effluent originating from the synthesis gas conditioning unit;
an acidic-gas removal unit that removes the acidic gases contained in the scrubbed effluent;
a purification unit for the final purification of the scrubbed and de-acidified effluent and comprising at least a guard bed;
a catalytic Fischer-Tropsch synthesis reaction unit.

As a result, the installation may enable implementation of the process described in the Applicant's patent application FR 2 997 414.

In addition, the drying unit and/or the torrefaction unit comprises a device as described hereinabove. By virtue of this device, the feedstock treatment performance and therefore the performance of the installation can be improved.

Furthermore, the drying unit and/or the torrefaction unit advantageously comprises a multiple-hearth furnace.

As a preference, the installation further comprises at least a hydrotreatment and/or isomerization unit acting on the hydrocarbon fractions originating from the catalytic Fischer-Tropsch synthesis reaction unit.

The installation thus makes it possible to reap the benefits of the hydrocarbon fractions through the production of very high quality liquid hydrocarbons, namely bio-naphtha, bio-petroleum, bio-kerosene, bio-diesel and bio-lubricants.

FIG. 3 illustrates, in a schematic and non-limiting manner, an example of a drying or torrefaction device according to the invention.

This drying or torrefaction device (which may be a treatment device in a broader sense) comprises a furnace 301, such as a multiple-hearth furnace, with an enclosure of which the longitudinal axis is vertical. A feedstock, preferably biomass, may be introduced at the top of the furnace 301 via the inlet 316, the treated feedstock re-emerging from the furnace 301 via one or more outlets 304 (in this instance two outlets 304) positioned at the bottom of the furnace, such that the feedstock moves under the effect of gravity through the furnace. One or more gas inlets 307 are also positioned on the furnace 301, as are one or more gas outlets 318. Thus, the feedstock, preferably a solid feedstock such as biomass, can be brought into contact with a gas, preferably a hot gas, in the furnace, so as either to dry the feedstock (in order to reduce the moisture content thereof) or to torrefy same.

The gas can circulate in a co-current or in a counter-current manner in relation to the feedstock in the furnace 301.

The furnace 301 may comprise one or more horizontal hearth-plates 302 to encourage the exchange of heat between the gases and the feedstock and promote contact between them. When the furnace 301 is a multiple-hearth furnace, it comprises a central shaft able to rotate, and driving agitation arms with teeth fixed to the agitation arms and directed towards the hearth-plates 302 of the furnace 301. The agitation arms extend radially from the central shaft. The agitation arms and the teeth then improve the mixing of the feedstock and of the gases and allow the feedstock to be routed from a feedstock inlet onto each hearth-plate towards a feedstock outlet of each hearth-plate in order to reach the hearth-plate below.

The drying or torrefaction device comprises a recovery system 306 with a recovery line 305 fixed to at least one treated feedstock outlet 304 (and preferably to all the outlets 304). The recovery line 305 comprises a sampling and/or analysis means 319 (which may be a means for taking a sample of the feedstock, or an in-line analyser for example).

The recovery line 305 comprises, downstream of the sampling and/or analysis means 319, a branching 311 with several lines in parallel, of which at least one line is a removal line 310 and at least one line is a recirculation line 312 (in this instance there are three recirculation lines 312).

The removal line 310 leads to a storage tank 308 and the recirculation lines 312 each lead to a port 303 in the furnace 301. Each recirculation line 312 advantageously terminates at a port 303 situated at a different altitude in the furnace 301, so as to allow the feedstock to be recirculated so that it has a longer or shorter residence time (time of recirculation) in the furnace 301.

As depicted, the furnace may be a multiple-hearth furnace having six hearth-plates 302, and the ports 303 for each recirculation line 312 terminate at a hearth-plate able to cause the feedstock to circulate from the outside towards the inside.

When the treated feedstock re-emerges from the furnace via the outlet 304 (or via the outlets 304), it is conveyed by the recovery line 305 of the recovery system 306. The treated feedstock is then analysed via the sampling and/or analysis means 319. For example, an in-line analysis may be performed using an infrared or microwave analyser for determining the feedstock moisture content continuously and in-line. The level of torrefaction can also be characterized by the colour of the feedstock (this being done by the user or by an optical colour-determination system). Alternatively, a sampling means for taking a sample may be permissible, the sampling means then acting as the sampling and/or analysis means 319.

The sample taken can then be analysed by measuring the upper calorific value and/or the lower calorific value in order to determine the level of torrefaction or by placing the sample in an oven and measuring its mass before and after it has been in the oven so as to determine its moisture content.

Depending on the moisture content or on the level of torrefaction, the treated feedstock can then either be sent to the storage tank 308 via the removal line 310 if the measured level meets the predefined criteria (the feedstock is then fully treated), or the feedstock can be sent to a recirculation line 312 in order to increase the level of drying (in order to reduce the moisture content) or the level of torrefaction. If the measured level is far from the predefined minimum criterion, the partially treated feedstock can be reintroduced into the top part via the topmost port 303. If, on the other hand, the measured level is close to but below the predefined minimum criterion, the partially treated feedstock can be reintroduced into the bottom part via the bottommost port 303. In other words, the introduction port 303 (and therefore the recirculation line 312 associated with this port 303) is selected according to the moisture content or the level of torrefaction measured by the sampling and/or analysis means 319 and according to the predefined criteria for the level of drying and torrefaction. Each removal line 310 or recirculation line 312 comprises at least one valve 309 or 313 (or any other throttling means) that allows the treated feedstock to be made to circulate in the relevant line or, on the other hand, to prevent such circulation.

The valve 309 of the removal line 310 is upstream of the storage tank 308 and the removal line 310 may also comprise another throttling means 307, downstream of the storage tank 308, to empty the storage tank (for example into a vehicle) or, on the other hand, to prevent the feedstock stored in the storage tank 308 from escaping.

The recirculation lines 312 may also comprise intermediate tanks 314 to create a buffer store of feedstock, before the feedstock is reintroduced into the furnace 301 via the port 303 of the relevant recirculation line 312. In that case, the valve 313 is then upstream of the intermediate tank 314 in order to prevent the storage of an undesired feedstock in the intermediate tank 314 of the line and the recirculation line 312 may also comprise another throttling means 315 downstream of the intermediate tank 314, so as to control the introduction of feedstock from the intermediate tank 314 into the furnace 301.

For example, each intermediate tank 314 may be devoted to the storage of a feedstock having a moisture content or level of torrefaction that falls within a predetermined range.

For example, the tank for the recirculation line 312 that terminates at the topmost port 303 into the furnace corresponds to a level of drying comprised between a first value and a second value; the tank for the recirculation line 312 that terminates at the intermediate-altitude port into the furnace 301 corresponds to a level of drying comprised between the second value and a third value; the tank for the recirculation line 312 that terminates at the lowest-altitude port into the bottom of the furnace 301 corresponds to a level of drying comprised between the third value and the minimum value of the predefined criterion. Thus, the measured moisture content or the measured level of torrefaction determines to which recirculation line or storage line the feedstock is to be circulated (and possibly in which storage tank or intermediate tank it is to be stored). It is even possible to render this circulation completely automated according to the value obtained by the sampling and/or analysis means 319.

Of course, the recovery system may comprise more than three recirculation lines or fewer than three recirculation lines, the position of the various ports thus being able to be adapted according to the altitude on the furnace and the circulation in each of these lines may be dependent on the measured moisture content or level of torrefaction.

The valves or throttling means 307, 309, 313 and/or 315 may be gate valves, swing valves or rotary feeders feeding onto endless screws.

The flow rate of the feedstock entering the furnace via the inlet 316 can be adapted according to the flow rate of the recirculated feedstock.

Advantageously, the injection means (for injecting the feedstock via the inlet 316 and/or the gas via the inlets 317) may ensure the absence of oxygen in the furnace 301.

For example, it is possible to create a torrefaction device such as a torrefier containing six hearth-plates as per FIG. 3, with a dry biomass supply at a flow rate of 5 t/h (5000 kg/h) at the inlet 316 of the furnace and with a target level of torrefaction (AWL) corresponding to 25% anhydrous weight loss. The torrefaction process may then consider the following different recirculations:
Levels of torrefaction in excess of 25% are considered to meet the predefined criteria (the predefined criteria are then comprised between 25% and 100%) and the feedstock is then fed to the storage tank 308 via the removal line 310 (and the opening of the throttling means 309), for example so as to use the torrefied feedstock in another unit downstream (notably a comminution, pneumatic transport or thermochemical conversion unit).
With a level of torrefaction of between 10 and 25%, the feedstock may be conveyed to the intermediate tank 314 of the recirculation line terminating at the bottom-most port 303 into the furnace 301. The biomass is torrefied but nevertheless requires a small amount of additional heat treatment.
With a level of torrefaction of between 5 and 15%, the feedstock may be conveyed to the intermediate tank 314 of the recirculation line terminating at the port situated at mid-height of the furnace 301, so that the torrefied feedstock can be reinjected into the middle of the furnace. Thus, an additional heat treatment is performed.
With a level of torrefaction of below 10%, the feedstock may be conveyed to the intermediate tank 314 of the recirculation line terminating at the topmost port into the furnace 301. Therefore, this insufficiently torrefied biomass undergoes complete thermal breakdown in the furnace.

In another example, it is possible to create a drying device such as a dryer containing six hearth-plates as per FIG. 3, with a dry biomass supply at a flow rate of 5 t/h (5000 kg/h) at the inlet 316 of the furnace and a target moisture content of 10%. The drying process may then consider the following different recirculations:
A level of torrefaction of below 10% is considered to meet the predefined criteria (the predefined criteria are then comprised between 0% and 10%) and the feedstock is then fed to the storage tank 308 via the removal line 310 (and the opening of the throttling means 309), for example so as to use the dried feedstock in another unit downstream (a torrifier, for example).
With a moisture content of between 10 and 20%, the feedstock may be conveyed to the intermediate tank 314 of the recirculation line terminating at the bottom-most port 303 into the furnace 301. The biomass is dried but nevertheless requires a small amount of additional heat treatment.
With a moisture content of between 15 and 25%, the feedstock may be conveyed to the intermediate tank 314 of the recirculation line terminating at the port situated at mid-height of the furnace 301, so that the partially dried feedstock can be reinjected into the middle of the furnace. Thus, an additional heat treatment is performed.
With a moisture content of above 25%, the feedstock may be conveyed to the intermediate tank 314 of the recirculation line terminating at the topmost port into the furnace 301. Therefore, this insufficiently dried biomass then undergoes a complete drying step in the furnace.

Thanks to the recirculating of the feedstock, the quantity of feedstock that conforms to the predefined criteria of moisture content or level of torrefaction can be improved, and the drying or torrefaction performance can thus be improved.

In addition, it is possible to perform recirculation that is differentiated according to the discrepancy in relation to the reference, thereby avoiding overheating and optimizing the residence time that the recirculated feedstock spends in the enclosure.

The invention therefore makes it possible to reduce the amount of treated (dried or torrefied) feedstock produced that does not meet the predefined criteria.

1. A device for the treatment of a feedstock containing solid particles, the treatment preferentially being drying or torrefaction, the device comprising a furnace (301) comprising an enclosure of which the longitudinal axis is vertical in the operating position, the enclosure comprising at least an inlet (316) and an outlet (304) for said feedstock and at least an inlet (317) and an outlet (318) for a gas able to come into contact with the solid particles, characterized in that the device comprises a feedstock recovery system (306) for recovering said feedstock, the feedstock recovery system (306) comprising at least a recovery line (305) connected to the feedstock outlet (304) of the enclosure, the recovery line (305) being in fluidic connection with a sampling and/or analysis means (319), for the in-situ or ex-situ analysis of the feedstock so as to measure a parameter indicative of the treatment of the feedstock, the recovery line (305) comprising at least two lines in parallel downstream of the sampling and/or analysis means (319), in the direction of circulation of the feedstock, at least one of the lines being a removal line (310), the removal line preferably leading to a storage tank (308), and at least another line being a recirculation line (312) leading to a port (303) allowing the feedstock to be reintroduced into the furnace (301), each removal or recirculation line comprising a throttling means (309, 313).

2. The device according to claim 1, wherein the recovery system (306) comprises a control means for controlling the opening and closing of the throttling means (309, 313).

3. The device according to claim 1, wherein the feedstock recovery system (306) comprises several recirculation lines (312) each leading to a different port (303) into the enclosure, the various ports (303) for the various lines being situated at different altitudes along the enclosure.

4. The device according to claim 1, wherein at least one recirculation line (312) comprises an intermediate tank (314) situated between the throttling means (309, 313) of the recirculation line (312) and the port (303) for reintroducing the feedstock into the furnace (301).

5. The device according to claim 1, wherein the indicative parameter is the measurement of the moisture content of the feedstock and either the sampling and/or analysis means comprises a sampling means, an oven and a mass-measuring system for measuring the mass before and after the feedstock passes through the oven, the difference in mass being indicative of the moisture content of the feedstock, or the sampling and/or analysis means comprises an in-line analyzer for measuring the moisture content of the feedstock in situ.

6. The device according to claim 4, wherein the indicative parameter is the level of torrefaction of the feedstock and either the sampling and/or analysis means comprises a feedstock sampling means and a device for measuring the upper calorific value and/or the lower calorific value, the upper calorific value and/or the lower calorific value being directly linked to the level of torrefaction of the feedstock, or the sampling and/or analysis means comprises an in-line system for characterizing the color of the feedstock, the colour of the feedstock being directly linked to the level of torrefaction.

7. The device according to claim 1, wherein the furnace (301) is a multiple hearth furnace, the enclosure comprising:
a plurality of hearth-plates (302) distributed along the longitudinal axis in the operating position, each hearth-plate (302) comprising an upper surface able to receive solid particles and at least one passage opening allowing the solid particles and the gas to pass through said hearth-plate (302),
at least one agitation arm associated with each hearth-plate (302), each agitation arm comprising agitation teeth extending from the agitation arm towards the upper surface of the hearth-plate (302) associated with the agitation arm,
means for driving the rotation of the agitation arms about the longitudinal axis of the enclosure,
the port (303) for each recirculation line (312) being situated above one of said hearth-plates (302) so as to introduce the feedstock at the level of said hearth-plate (302), each recirculation line (312) preferably allowing the feedstock to be introduced at the level of a different hearth-plate (302).

8. A process for the drying or torrefaction of a feedstock made up of solid particles using a device as claimed in claim 1, wherein at least the following steps are performed:
said feedstock containing solid particles, and a gas are introduced into the furnace (301);
the dried or torrefied feedstock is recovered at the outlet of the furnace (301);
a parameter indicative of the drying or of the torrefaction of the feedstock is measured using the dried or torrefied feedstock leaving the furnace (301);
depending on said indicative parameter measured, said dried or torrefied feedstock is sent to a removal line (310) and/or the dried or torrefied feedstock is sent to at least one recirculation line (312) so that it can be reintroduced into the furnace (301).

9. The process according to claim 8, wherein, depending on said indicative parameter, the dried or torrefied feedstock is introduced into a recirculation line (312) which terminates at a port (303) defined according to its altitude in the furnace (301).

10. The process Process-according to claim 8, wherein the measuring of the indicative parameter is performed in-line by an analyzer.

11. The process according to claim 8, wherein the measuring of the indicative parameter is performed by taking a sample of the dried or torrefied feedstock using the sampling and/or analysis means, the measurement being performed on the sample off-line.

12. The process Process-according to claim 8, wherein the indicative parameter is a moisture content of the feedstock and for which the mass of the taken sample is measured, then the taken sample is placed in an oven in order to eliminate the moisture it contains and the mass of the taken sample that has been in the oven is measured, the moisture content being defined as the ratio of the difference between the mass of the taken sample and of the taken sample which has been in the oven, to the mass of the taken sample.

13. The process according to claim 8, wherein the indicative parameter is a level of torrefaction of the feedstock and wherein the upper calorific value and/or the lower calorific value of the taken sample is/are measured, the upper calorific value and/or the lower calorific value being directly linked to the level of torrefaction.

14. An installation for producing liquid hydrocarbons from a feedstock containing at least a fraction of biomass and possibly at least a fraction of another feedstock, comprising:
at least a feedstock-pre-treatment unit comprising a drying unit, a torrefaction unit, possibly a granulation unit, and a comminution unit;
possibly a combination unit comprising a pipe able to reunite the effluents originating from the various pre-treatment units;
a gasification unit for gasifying the pre-treated effluents and comprising at least an entrained-flow reactor;
a conditioning unit for conditioning the synthesis gas and comprising:
a scrubbing unit for scrubbing the gas stream with water and fractionating it so as to split the stream of synthesis gas into at least two effluents;
at least a guard bed for eliminating halogenated compounds in one of said two effluents situated upstream of a conversion unit for the steam conversion of carbon monoxide;
a catalytic hydrolysis unit;
a recombining unit recombining the effluents originating respectively from the steam carbon monoxide conversion unit and from the catalytic hydrolysis unit;
a scrubbing unit that uses water to scrub the effluent originating from the synthesis gas conditioning unit;
an acidic-gas removal unit that removes the acidic gases contained in the scrubbed effluent;
a purification unit for the final purification of the scrubbed and de-acidified effluent and comprising at least a guard bed;
a catalytic Fischer-Tropsch synthesis reaction unit,
characterized in that the drying unit and/or the torrefaction unit comprises a device as claimed in claim 1.

15. The installation according to claim 14, further comprising at least a hydrotreatment and/or isomerization unit acting on the hydrocarbon fractions originating from the catalytic Fischer-Tropsch synthesis reaction unit.

16. The device according to claim 2, wherein the control means is connected to said sampling and/or analysis means (319).

17. The device according to claim 1, wherein the indicative parameter is the measurement of the moisture content of the feedstock and either the sampling and/or analysis means comprises a sampling means, an oven and a mass-measuring system for measuring the mass before and after the feedstock passes through the oven, the difference in mass being indicative of the moisture content of the feedstock, or the sampling and/or analysis means comprises an in-line analyzer, using infrared or microwaves, for measuring the moisture content of the feedstock in situ.

18. The device according to claim 1, wherein each recirculation line (312) comprises an intermediate tank (314) situated between the throttling means (309, 313) of the recirculation line (312) and the port (303) for reintroducing the feedstock into the furnace (301).
